(19) United States
(12) Patent Application Publication
(10) Pub. No.: US 2014/0218452 A1
(43) Pub. Date: Aug. 7, 2014

(54) INKJET PRINTING SYSTEMS FOR PERMANENT PRINTING ON NONPOROUS SURFACES

(71) Applicant: Hallyuen Holdings Ltd., Hong Kong (HK)

(72) Inventors: Pei LI, Hong Kong (HK); Kin Man HO, Hong Kong (HK); Chun Ho YAM, Hong Kong (HK); Siu Sun CHAN, Hong Kong (HK); Kwai Sang NG, Hong Kong (HK)

(73) Assignee: Hallyuen Holdings Ltd., Hong Kong (HK)

(21) Appl. No.: 14/173,487

(22) Filed: Feb. 5, 2014

Related U.S. Application Data
(60) Provisional application No. 61/760,753, filed on Feb. 5, 2013.

(51) Int. Cl. B41J 11/00; B41J 2/01

(52) U.S. Cl. CPC B41J 11/002; B41J 2/01
USPC 347/100

(57) ABSTRACT

An inkjet printing system for printing permanent marks on a variety of nonporous substrate surfaces is provided. The system involves three components: 1) An inkjet printer; 2) An adaptable inkjet ink for the inkjet printer, and 3) A heating element. The present system can instantly produce permanent marks on nonporous surfaces after inkjet printing. The resulting permanent marks are impervious to chemical and physical removal, thus prohibiting fraudsters to tamper packaging information.

This nonprovisional application claims priority to U.S. Provisional Application No. 61/760,753, which was filed on Feb. 5, 2013, and which is herein incorporated by reference.

### BACKGROUND OF THE INVENTION

1. Field of the Invention

The present invention relates to inkjet printing systems for permanent printing on nonporous surfaces.

2. Description of the Background Art

Inkjet printing is a well-known technique for printing or marking information such as manufacturing and/or expiration dates, lot number, manufacturing location etc. on packages of consumer products. These products include dairy, beverage, snack, food products, plastic bottles, PVC pipe, electrical wiring, and many others. The markings provide useful information for manufacturers to track their products from production line to retail locations. Therefore, product traceability is an important issue in protecting public health and managing supply chain. It allows manufacturers or public agencies to quickly and accurately identify any contaminated or problem products, thus removing them from the marketplace.

In recent years, the spread of counterfeit goods and a range of goods subject to infringement are increasing considerably worldwide. Reselling of spoiled, lost inventory and contaminated products also happen frequently, thus threatening public health. In fact, packaging information printed with current inkjet printing technology is vulnerable to deliberate tampering because traditional prints can be easily removed by chemical solution such as an organic solvent. Thus unscrupulous distributors and proprietors could easily alter expiry date by wiping them off and then reprinting untruth information. To overcome these acute problems, printing technologies and systems which can print permanent or indelible markings on packaging surface to ensure product information and traceability is in urgent demand by various industries.

In last decade, permanent inkjet ink formulations have been developed and used in printing codes or markings of industrial products from high speed production line with a “continuous inkjet” (CIJ) printing technology. The ink formulations used in the inkjet printing technology can be classified into three types: 1) Penetration inks (U.S. Pat. No. 6,412,939, U.S. Pat. No. 7,081,158, U.S. Pat. No. 7,297,201 B2, U.S. Pat. No. 7,833,334, U.S. Pat. No. 8,282,724); 2) Hot melt inks (U.S. Pat. No. 5,700,313, U.S. Pat. No. 6,106,602); and 3) UV-curable inks (U.S. Pub. No. 7,064,153 B2, U.S. Pat. No. 7,845,785).

The penetration ink is a kind of inkjet ink, which requires the use of penetrant, aiding the colorants into the substrate. Thus marks on the substrate cannot be removed when dried unless destroying the substrate surface. This kind of ink has been used in the CIJ inkjet printing system. However, this kind of ink suffers from some critical drawbacks which limits their potential applications: (1) Depth of ink penetration is difficult to control because of different substrate thickness, molecular structure and morphology. As a result, a possible contamination of the ink formulation into the product especially the food products, is of a serious concern. (2) Formation of permanent markings is a time-consuming process. It usually needs a few hours to days to achieve the satisfactory result due to slow penetration rate of the ink into the substrate. (iii) The penetrant is usually a high boiling point substance, thereby resulting in a slow drying rate of the ink. Therefore, special care is needed in handling because the wet markings are easily smudged by objects and hands.

The hot melt ink is liquidified at its melting temperature, but becomes solidified at ambient temperature, thus drying instantly after printing. The hot melt ink can form permanent marks on a variety of plastics, metals, high gloss, etc. Although solidified ink has poor solubility in many organic solvents at room temperature, the marking is still removable with a hot organic solvent.

UV-curable ink is an emerging technique to produce permanent prints with good physical and chemical resistance, for example, printing color imaging and 2-dimensional bar code. To achieve ink coating with good physical and chemical resistance, the UV-curable ink usually requires the use of high molecular weight of UV-curable resin. However, the use of resin often results in ink formulation with high viscosity, thus limiting its applicability in high speed printing system (i.e., CIJ printing technique). To solve this problem, U.S. Pat. No. 7,064,153 B2 has recently disclosed a low viscosity UV-curable inkjet ink formulation. Through replacing the high molecular weight of UV-curable resins with monofunctional vinylic monomers, viscosity of the UV-curable ink can be considerably reduced, thus permitting its usage in the continuous inkjet printer for marking on glass substrate. However, applicability of this kind of UV ink technology in high speed packaging markings is still not feasible due to the use of expensive UV curing system (i.e., UV lamp). Furthermore, the cure efficiency of the ink (i.e., the chemical resistance) is sensitive to surrounding environment (i.e., humidity and temperature) and purity of ink. Furthermore, the presence of oxygen can strongly affect the UV curing rate. Therefore, a well-conditioned environment for ink curing purpose needs to be installed.

### SUMMARY OF THE INVENTION

It is therefore an object of the present invention to provide to overcome the disadvantages and problems in the prior art.

In an embodiment, the present invention relates to an inkjet printing system for permanent printing on various packaging materials such as plastics, metals, and papers. The system includes the components of: an inkjet printer; an adaptable inkjet ink for the inkjet printer, and a heating element. The present system can produce permanent markings on nonporous surfaces of the substrates, wherein the markings are impervious to any chemical and physical alterations. The present invention not only overcomes those problems associated with prior arts as mentioned above, but also demonstrates a new inkjet printing system to create permanent markings on nonporous substrate surfaces for a high-speed production line. Unlike those methods reported in the prior art, this printing system combines an inkjet printer, a new ink formulation and a thermal treatment method for printing permanent marking on nonporous surfaces.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein the sole figure shows a method of inkjet printing system and a process used in an embodiment of the present invention.

### DETAILED DESCRIPTION

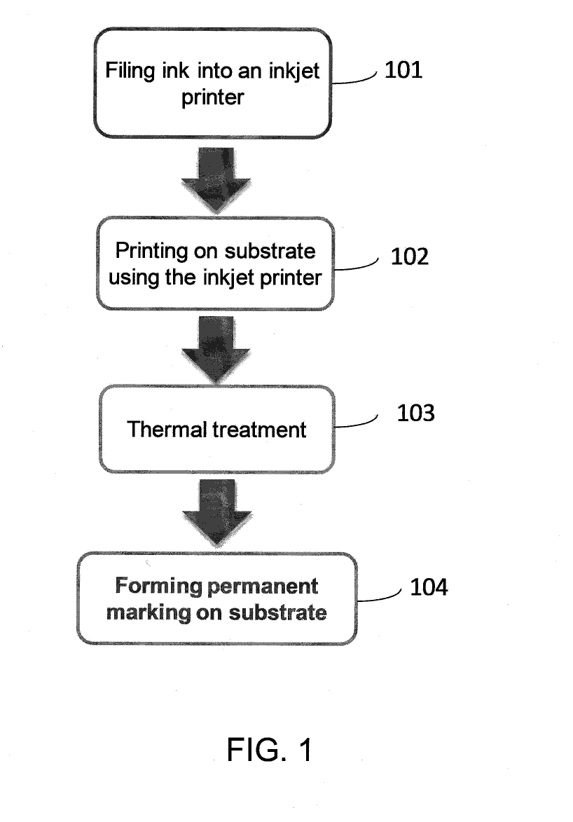

FIG. 1 is an embodiment of the method used in the present invention, wherein an adaptable inkjet ink is filled into an inkjet printer 101; the ink is printed on a substrate 102; the substrate is subjected to thermal treatment 103; the ink produces permanent marking on a substrate 104.

The ink formulation in accordance with the present invention is applied to a non-porous surface using any kinds of commercial inkjet printers, preferably a continuous inkjet (CIJ) printer. Examples of CIJ printer are Domino A series printers, Leibinger Jet 2 series, EBS-6000 series, KGK CCS series, etc. The inkjet ink formulation is capable of forming permanent marks on nonporous polymer surfaces after thermal treatment. Examples of polymer surfaces include plastics, as well as polymer coatings on metal and paper surfaces, in particularly, polyethylene (PE), polypropylene (PP), epoxy, polyethylene terephthalate (PET), nylon, or of any other nonporous or porous substance or composite of a plurality of the foregoing materials.

The inkjet ink formulation of the present invention comprises: (i) A solvent system, comprising of the composition varying from 30 to 90% by weight. (ii) A one or more colorants, comprising the composition varying from 0.1 to 20% by weight. (iii) A one or more binder resins, wherein the composition varying from 0.1 to 35% by weight. (iv)Additives with the composition varying from 0.1 to 15% by weight.

The ink properties according to the invention have viscosities ranging from 2 to 10 mPa·s and electrical conductivity generally higher than 300 μS/cm at 20° C.

The solvents used in the ink formulation in the present invention comprise one or two or more types of solvents. Volatile solvents are the major component while low volatile and viscous solvents are the minor component. This kind of solvent mixture allows rapid drying of the ink and adjusting the solution viscosity to the desired range of 2 to 10 mPa·s for the inkjet printer.

The solvent system comprises a combination of lower alkanol containing 1 to 3 carbon atoms, for example, methanol, ethanol, propanol, etc, a lower aliphatic ketone, typically acetone, dimethyl ketone, methyl ethyl ketone, methyl propyl ketone, methyl isobutyl ketone and ethyl propyl ketone, diisobutyl ketone, cyclohexanone, isophorone, etc, as well as, other solvents, for example, ethyl acetate, isopropyl acetate, propyl acetate, butyl acetate, isobutyl acetate, penta(amyl) acetate, etc. A preferred volatile solvent component is a mixture of methyl isobutyl ketone and methyl ethyl ketone.

Low volatile solvents used in the present invention comprise one or more glycol or glycol ether solvents, or any suitable glycol. Examples of glycol include diethylene glycol, triethylene glycol, dipropylene glycol, and tripropylene glycol. Any suitable glycol ether can be used, for example, glycol ethers of ethylene glycol and propylene glycol, such as monoalkyl ethers of ethylene glycol, diethylene glycol, triethylene glycol, propylene glycol, dipropylene glycol, and tripropylene glycol. Examples of diethylene glycol ethers include diethylene glycol monomethyl ether, monoethyl ether, and monopropyl ether, and monobutyl ether. Examples of triethylene glycol ethers include triethylene glycol monomethyl ether, monoethyl ether, and monopropyl ether, and monobutyl ether. Examples of dipropylene glycol ethers include dipropylene glycol monomethyl ether, monoethyl ether, and monopropyl ether, and monobutyl ether. Examples of carbonate solvents comprise dimethyl carbonate, diethyl carbonate, ethylene carbonate, propylene carbonate, etc. Examples of propionate esters such as n-butyl propionate, n-pentyl propionate and ethylene glycol monoethylether propionate are also suitable. Other examples of low volatile solvents are diacetone alcohol, dimethyl formamide, dimethyl acetate, N-methyl pyrroldine, etc. Any combination of such solvents can also be used, for example, a mixture of a glycol and a glycol ether, such as a mixture of diethylene glycol and tripropylene glycol monomethyl ether, can be used. Other types of low volatile solvents include a hydrocarbon solvent or even water, or in combination with other solvents described above. The present invention provides, in an embodiment, an inkjet ink composition wherein the volatile and low volatile solvent mixture is present in a range of about 30% to 90% by weight.

The colorant is used to provide a dark, clearly visible marking on substrates. Any suitable colorants such as “pigments or dyes” can be used. The insoluble pigments are dispersed as fine nanoparticules in a solvent or a mixture of solvents. The soluble dye in a selected solvent or a mixture of selected solvents can endow the ink formulations with sufficient conductivities which meet the requirements of various types of CIJ printers. Examples of the dyes are Solvent Black 27, Solvent Black 29, Solvent Black 35 and Solvent Black 45.

A combination of two or more colorants may be used to enhance print intensity. The compositions of colorants are less than 20%, and preferably less than 15% by weight of the inkjet ink composition. Examples of colorants include Pigment Black 7, Pigment Black 23, Pigment Black 28, Pigment Brown 6, Pigment Brown 24, Pigment Blue 15:1, Pigment Blue 28, Pigment Blue 29, Pigment Blue 36, Pigment Blue 72, Pigment Green 36, Pigment Green 50, Pigment violet 23, Pigment red 209, Pigment Yellow 42, Pigment Yellow 53, Pigment Yellow 119, Solvent Blue 35, Solvent Blue 36, Solvent Blue 45, Solvent Blue 59, Solvent Blue 63, Solvent Blue 67, Solvent Blue 68, Solvent Blue 70, Solvent Blue 78, Solvent Blue 94, Solvent Blue 97, Solvent Blue 101, Solvent Blue 104, Solvent Black 3, Solvent Black 7, Solvent Black 27, Solvent Black 29, Solvent Black 34, Solvent Black 35, Solvent Black 48, and but not limited to any color of colorants.

Optional components may be added to the ink to provide security of the printing marks under any kinds of physical or chemical trigger. For example, the presence of fluorescent colorant in the ink formulation allows observing markings under a weak UV irradiation. This component in the ink composition is generally less than 5%, typically from about 0.1% to 2%.

Binder resins are used to stabilize the colorants and promote colorants to adhere on the substrates. Examples of binder resins include aldehyde-ketone resins, epoxy resins, rosin esters, phenolic modified rosin resin, fumaric modified rosin resin, maleic modified rosin resin, hydrogenated rosin resin, dimerized rosin resin, silicon resins, alkyl benzene-sulfonamide resins, vinyl resins, cellulose derivatives, styrene-acrylic resins, acrylic resins, polyurethanes, polyester resins, polyamides, poly(vinyl butyral) resins, aldehyde resins, phenolic resins, etc. It is preferable to use a combination of two or more binder resins in order to provide better balance between the adhesion ability and ink viscosity.

The ink composition also contains one or more plasticizers for solubilizing binder resins. Examples of plasticizers, depending on the resin used, are diethyl phthalate, di-n-butyl phthalate, diisobutyl phthalate, di-n-hexyl phthalate, bis(2-ethylhexyl) phthalate, diisodecyl phthalate, diisononyl phthalate, 1,2-cyclohexane dicarboxylic acid diisonoyl ester, tri-(2-ethyl hexyl)trimellitate, tri-(n-octyl, n-decyl)trimellitate, tri-(heptyl, nonyl)trimellitate, n-octyl trimellitate, bis(2-ethylhexyl)adipate, etc. The composition of binder resins and plasticizers in the ink composition according to the invention is ranged from 5 to 75% by weight, preferably 0.5 to 50% by weight.

The inkjet ink composition may also contain the following additives: surface modifiers, accelerators, bactericides, defoaming agents, conducting agents, etc. Their content is preferably from 0.1 to 15% by weight, more preferably from 0.1 to 10% by weight.

Surface modifiers are used to regulate the surface tension of inkjet ink. Examples of surface modifiers are not limited to any kinds of non-ionic surfactant or an ionic surfactant. Typical examples include a fluorosurfactant, a siloxane-based surfactant, an acetylenic diol-based surfactant, a hydrocarbon-based surfactant, and/or their mixtures. It is preferable to combine two or more surface modifiers in order to optimize the jetting stability.

Accelerators are used to promote ink components fusing with the substrate surface within a short heating time. Examples of surface modifiers include: 1,1′-azobis(cyclohexanecarbonitrile), 2,2′-azobisisobutyronitrile (AIBN), tert-amyl peroxybenzoate, 4,4-azobis(4-cyanovaleric acid), 2,2-bis(tert-butylperoxy)butane, 1,1-bis(tert-butylperoxy)cyclohexane, 1,1-bis(tert-butylperoxy)cyclohexane, 2,5-bis(tert-butylperoxy)-2,5-dimethylhexane, 2,5-bis(tert-butylperoxy)-2,5-dimethyl-3-hexyne, bis(1-(tert-butylperoxy)-1-methylethyl)benzene, 1,1-bis(tert-butylperoxy)-3,3,5-trimethylcyclohexane, tert-butyl hydroperoxide, tert-butyl peracetate, tert-butyl peroxide, benzoyl peroxide, lauroyl peroxide, cyclohexanone peroxide, dicumyl peroxide, 2,4-pentanedione peroxide, tert-butyl peroxybenzoate, tert-butylperoxy isopropyl carbonate, cumene hydroperoxide, peracetic acid and potassium persulfate. It is preferable to combine two or more surface modifiers in the ink formulation.

Conducting salt is often necessary to provide conductivity in ink formulation. A conducting salt that is different from the dyes and that is generally chosen from among the salts of alkali metals, alkaline earth metals and quaternary ammonium. The counter ions are either in the form of halides (chlorides, bromides, iodides, fluorides), perchlorates, nitrates, thiocyanates, formates, acetates, sulfates, propionates, hexafluorophosphates, hexafluoroantimonates, etc.

The inkjet ink composition can be prepared by any suitable methods. For example, all required ingredients are mixed at room temperature or upon heating, followed by filtering the ink to remove any undesirable materials.

The present invention provides, in an embodiment, an adaptable inkjet ink composition wherein the solvent is present in a composition varying from 30 to 90% by weight. The binder resins is present in a composition varying from 0.1 to 35% by weight, The colorant content is present in a composition varying from 0.1 to 20% by weight. The additives are present in a composition varying from 0.1 to 15% by weight.

The ink composition according to the invention has viscosities ranging from 2 to 10 mPa·s and electrical conductivity is generally greater than 300 μS/cm at 20° C.

The heating element is installed after inkjet printer in a production line. The function of a heating element is to promote rapid drying of inks and fusion of ink components with the substrates, producing permanent markings on nonporous surface. The heating element used in the present invention can be either conventional heating or infrared (IR) radiant heating, preferably IR radiant heating. Examples of the heating element of IR heating lamp include quartz, quartz tungsten, carbon, gas-fired, etc, preferably quartz and carbon. The heating length can be ranged from 20 to 200 cm, preferably 55 cm. To achieve permanent marking on the surface, the surface temperature of a substrate according to the ink formulation (Example 1) shall be in the range between 45 and 150° C., preferably in the range from 60 to 100° C. Other factors affecting the efficiency of the ink formulation are the exposure time to IR radiation and distance between heating element and substrate surface. The exposure times of IR radiation are ranged from 1 to 20 seconds, preferably between 1 and 5 seconds. The distance between heating element and substrate is ranged from 0.5 cm to 10 cm, preferably 1.0 cm.

The inkjet ink printing system of this invention produces permanent marking on the surface of packaging materials. Permanent marking is defined as having a visible mark remaining after washing with or soaking either in aqueous or nonaqueous liquid for a set duration, for example, 24 hours. Examples of aqueous solutions are deionized water, liquid detergent, acid and alkaline solutions. Examples of organic liquids are methanol, ethanol, isopropyl alcohol, acetone, methyl ethyl ketone, tetrahydrofuran, dimethyl sulfoxide, ethyl acetate, chloroform, toluene, hexane, etc.

### EXAMPLE

The following two examples demonstrate inkjet ink compositions in accordance with an embodiment of the present invention. These examples also demonstrate permanent markings of the present invention.

TABLE 1

| | Example ink formulation#1 |
|---|---|
| Solvent system (g)¹ | 650 |
| Binder resins/plasticizer/additive | 350 |
| (g)² | |
| Colorant solution (g)³ | 260 |
| Total (g) | 1260 |
| Properties of ink | |
| Conductivity (μS/cm) at 25° C. | 350 |
| Viscosity (mPa · s) at 25° C. | 2.8 |

¹Solvent system contains 15% methyl isobutyl ketone, 65% methyl ethyl ketone and 20% diethylene glycol.
²The binder resins/plasticizer/additive mixture contains 34% maleic modified rosin resin, 38% aldehyde-ketone resins, 10% plasticizer, 18% additives.
³Colorant solution is prepared by mixing and milling 25% pigment black 7 and 25% solvent black 3 with 30% methyl ethyl ketone and 15% methyl isobutyl ketone.

TABLE 2

| | Example ink formulation#2 |
|---|---|
| Solvent system (g)¹ | 650 |
| Binder resins/plasticizer/additive | 350 |
| (g)² | |
| Colorant solution (g)³ | 260 |
| Total (g) | 1260 |
| Properties of ink | |
| Conductivity (μS/cm) at 25° C. | 750 |
| Viscosity (mPa · s) at 25° C. | 5.8 |

¹Solvent system contains 10% methyl isobutyl ketone, 75% methyl ethyl ketone and 15% diethylene glycol.
²The binder resins/plasticizer/additive mixture contains 30% poly(vinyl butyral) resins, 45% aldehyde-ketone resins, 5% plasticizer, 20% additives.
³Colorant solution is prepared by mixing and milling 25% pigment black 7, 15% solvent black 27, and 15% solvent black 3 with 30% methyl ethyl ketone and 15% ethylene carbonate.

Single or multi-layered polyethylene or its composite film was printed with ink formulated according to this invention with a continuous inkjet printer in a production line (40 meter/min). The printed sample immediately underwent a heating treatment with an IR heating lamp, wherein a lightened length was 55 cm and the distance between the lamp and substrate surface was 1 cm. The thermal treatment time depended on the speed of the sample moving on a conveyer belt, usually more than 1 second, preferably 2 to 3 seconds. To evaluate the permanent marking properties, marking area of the sample was cut into half, one half is used as an internal control, while the other half was completely immersed in a sealed glass vial for 24 hours in a solvent without any external agitation or abrasion. Sample was then removed and allowed it to dry. The prints were then compared with its control by a visual evaluation.

Table 3 shows test results of chemical resistance of various samples (traditional ink and ink formulation#1 & #2) by comparing with their internal controls. For the testing conducted in aqueous solution, all samples showed little changes in their optical densities. For the testing conducted in organic solvents, the markings printed using traditional ink were completely dissolved by some organic solvents except hexane. On a contrary, the marks printed using ink formulation#1 & #2 remain clearly visible with only slight reduction in optical density.

TABLE 3

| | | ink | ink |
|---|---|---|---|
| Printed marks | Control#1¹ | formulation#1 | formulation#2 |
| Deionized water | No effect | No effect | No effect |
| Liquid detergent | No effect | No effect | No effect |
| 4M Hydrochloric acid | No effect | No effect | No effect |
| solution | | | |
| 10% Sodium hydroxide | No effect | No effect | No effect |
| solution | | | |
| Methanol | X | V | V |
| Ethanol | X | V | V |
| Isopropyl alcohol | X | V | V |
| Acetone | X | V | V |
| Methyl ethyl ketone | X | V | V |
| Tetrahydrofuran | X | V | V |
| Dimethyl sulfoxide | X | V | V |
| Ethyl acetate | X | V | V |
| Chloroform | X | V | V |
| Toluene | BV | No effect | No effect |
| Hexane | No effect | No effect | No effect |

¹Black ink (Model IC-270BK) obtained from Domino printing, and printed on a multilayered polyethylene film
“V” = marks may be slightly reduced in optical density by comparing internal control, but is still clearly visible
“BV” = marks may be reduced in optical density by comparing internal control, but is barely visible
“X” = marks are completely removed

Having described an embodiment of the present system, it is to be understood that the present system is not limited to precise embodiment, and that various changes and modifications may be effected therein by one having ordinary skills in the art without departing from the scope or spirit as defined in the appended claims.

In interpreting the appended claims, it should be understood that the word “a” or “an” preceding an element does not exclude the presence of a plurality of such elements; any reference signs in the claims do not limit their scope; any of the disclosed device(s) or portions thereof may be combined together or separated into further portions unless specifically stated otherwise; and no specific sequence of acts or steps is intended to be required unless specifically indicated; The term “comprise”, “having”, “including”, and “containing” are to be construed as open-ended terms (i.e., meaning “including, but not limited to,”) unless otherwise noted; The use of any and all examples, or exemplary language (e.g., such as”) provided herein, is intended merely to better illuminate the invention and does not pose a limitation on the scope of the invention unless otherwise claimed.

What is claimed is:

1. An inkjet printing system for printing permanent markings on nonporous substrates comprising:
an inkjet printer;
an inkjet ink formulation; and
a heating element.

2. The inkjet printer system according to claim 1, wherein the inkjet printer is a commercial inkjet printer or a continuous inkjet printers.

3. The inkjet printing system according to claim 1, wherein the inkjet ink formulation forms permanent markings and good adhesion ability on nonporous substrate surfaces including plastic, metal, paper and others.

4. The inkjet printing system according to claim 3, wherein the ink comprises a solvent or a solvent mixture, one or more colorants, one or more binder resins, and additives.

5. The inkjet printing system according to claim 4, wherein the solvent or the solvent mixture is in a range from 30 to 90% by weight of the inkjet ink formultation.

6. The inkjet printing system according to claim 5, wherein the inkjet ink formulation further comprises at least one volatile solvent.

7. The inkjet printing system according to claim 6, wherein the volatile solvent is selected from the group of ketones, alcohol, ethers, esters, and combinations thereof.

8. The inkjet printing system according to claim 5, wherein the inkjet ink formulation includes one or more low volatile solvents.

9. The inkjet printing system according to claim 8, wherein the low volatile solvent is selected from the group of glycols, glycol ethers, carbonates, propionate esters, and combinations thereof.

10. The inkjet printing system according to claim 5, wherein the solvent mixture is a combination of methyl isobutyl ketone, methyl ethyl ketone and diethylene glycol.

11. The inkjet printing system according to claim 4, wherein at least one colorant or a mixture of colorants are present in an amount varying from 0.1 to 20% by weight.

12. The inkjet printing system according to claim 11, wherein the colorants are pigments or dyes, and preferably those “C. I. Solvent Dyes” and “C. I. Pigments”.

13. The inkjet printing system according to claim 11, wherein the inkjet ink formulation includes at least one colorant or a mixture of the colorants, of any color and any combination thereof.

14. The inkjet printing system according to claim 11, wherein the colorant for security marking is a fluorescent colorant.

15. The inkjet printing system according to claim 4, wherein the binder resins are present in the range from 0.1 to 35% by weight.

16. The inkjet printing system according to claim 15, wherein the binder resins are aldehyde and ketone resins, epoxy resins, rosin esters, phenolic modified rosin resin, fumaric modified rosin resin, maleic modified rosin resin, hydrogenated rosin resin, dimerized rosin resin, silicon resins, alkyl benzene-sulfonamide resins, vinyl resins, cellulose derivatives, styrene-acrylic resins, acrylic resins, polyurethanes, polyester resins, polyamides, poly(vinyl butyral) resins, phenolic resins, and combinations thereof.

17. The inkjet printing system according to claim 16, further comprising one or more plasticizers ranging from 0.5 to 75% relative to the weight of the binder resins.

18. The inkjet printing system according to claim 4, wherein the inkjet ink formulation includes one or more additives selected from surface modifiers, accelerators, conducting agents, defoaming agents, antioxidants, bactericides, and wherein their contents range from 0.1 to 15% by weight or from 0.1 to 10% by weight.

19. The inkjet printing system to claim 18, further comprising at least one or two surface modifiers ranging from 0.1 to 5% by weight.

20. The inkjet printing system according to claim 18, further comprising at least one or two accelerators ranging from 0.1 to 5% by weight.

21. The inkjet printing system according to claim 18, further comprising one or two conducting agents in an amount ranging from 0.1 to 5% by weight.

22. The inkjet printing system according to claim 1, wherein a heating element is a conventional heating source or an IR radiant heating source or an IR radiant heating source.

23. The inkjet printing system according to claim 22, wherein the IR radiant heating lamp is made of quartz-, quartz tungsten-, carbon- or gas-fired made.

24. The inkjet printing system according to claim 22, wherein a distance between the heating lamp and a substrate ranges from 0.5 to 10 cm, preferably 1.0 cm.

25. The inkjet printing system according to claim 22, wherein an exposure time of IR irradiation ranges from 1 to 20 second, depending on the substrate materials.

26. The inkjet printing system according to claim 22, wherein the temperature of surface substrates ranges from 45 to 150° C., depending on substrate materials.

27. The inkjet printing system according to claim 1, wherein the printed permanent markings are impervious to any chemical and physical alterations.
